(19) United States
(12) Patent Application Publication
(10) Pub. No.: US 2026/0001150 A1
(43) Pub. Date: Jan. 1, 2026

(54) CUTTING TOOL WITH HYDRAULICALLY CLAMPED CUTTING INSERTS

(71) Applicant: Kennametal Inc., Latrobe, PA (US)

(72) Inventor: Tyler GRIMM, Greensburg, PA (US)

(73) Assignee: Kennametal Inc., Latrobe, PA (US)

(21) Appl. No.: 18/760,182

(22) Filed: Jul. 1, 2024

(51) Int. Cl. B23C 5/10

(52) U.S. Cl. CPC B23C 5/109

(57) ABSTRACT

A cutting tool includes a cutter body having an outer surface and a plurality of insert-holding slots formed in the outer surface, and a plurality of cutting inserts held in the plurality of insert-holding slots by application of hydraulic clamping force on the plurality of cutting inserts. A method of manufacturing a cutting tool includes disposing a plurality of cutting inserts in a plurality of insert-holding slots formed in an outer surface of a cutter body, and holding the plurality of cutting inserts in the plurality of insert-holding slots by applying hydraulic clamping force to the plurality of cutting inserts.

### CROSS-REFERENCE TO RELATED APPLICATION

Not applicable.

### STATEMENT REGARDING FEDERALLY SPONSORED RESEARCH OR DEVELOPMENT

Not Applicable.

### BACKGROUND

### 1. Field of the Invention

The present invention relates to a cutting tool with hydraulically clamped cutting inserts.

### 2. Description of the Background Art

Known cutting tools, such as rotary indexable end mills, include cutting inserts that are removable for indexing, refurbishment, and replacement, for example. Known methods for fixing the cutting inserts in place can be expensive and/or unreliable, and can require fixation structures that take up significant space, thereby limiting the number of cutting edges per unit of circumferential length, depending on the circumference of the tool.

### SUMMARY

A cutting tool includes a cutter body having an outer surface and a plurality of insert-holding slots formed in the outer surface, and a plurality of cutting inserts held in the plurality of insert-holding slots by application of hydraulic clamping force on the plurality of cutting inserts. A method of manufacturing a cutting tool includes disposing a plurality of cutting inserts in a plurality of insert-holding slots formed in an outer surface of a cutter body, and holding the plurality of cutting inserts in the plurality of insert-holding slots by applying hydraulic clamping force to the plurality of cutting inserts.

In an embodiment, the plurality of cutting inserts and the plurality of insert-holding slots extend helically. In an embodiment, each of the plurality of insert-holding slots holds more than one of the plurality of cutting inserts. In an embodiment, the cutter body includes one or more hydraulic passageways configured to, when hydraulic fluid disposed therein is pressurized, cause walls of the plurality of insert-holding slots to apply the hydraulic clamping force to the plurality of cutting inserts. In an embodiment, each of the plurality of cutting inserts includes a dovetail-shaped portion to which the hydraulic clamping force is applied.

### BRIEF DESCRIPTION OF THE DRAWINGS

While various embodiments are illustrated in the drawings, the particular embodiments shown should not be construed to limit the claims. Various modifications and changes may be made without departing from the scope of the invention.

FIG. 1 illustrates a side view of a cutter body of a cutting tool of a first embodiment.

FIG. 2 illustrates a cross sectional view of the FIG. 1 cutter body taken along its longitudinal axis.

FIG. 3 illustrates a cross sectional view of the head of the FIG. 1 cutter body taken perpendicular to its longitudinal axis.

FIG. 4 illustrates a side view of a cutting insert of the cutting tool of the first embodiment.

FIG. 5 illustrates a cross-sectional view of the FIG. 4 cutting insert along line A-A of FIG. 4.

FIG. 6 illustrates a side view of the cutting tool of the first embodiment.

FIG. 7 illustrates a cross sectional view of the FIG. 6 cutting tool taken along its longitudinal axis.

FIG. 8 illustrates a cross sectional view of the head of the FIG. 8 cutting tool taken perpendicular to its longitudinal axis.

FIG. 9 illustrates a side view of a cutting tool of a first embodiment.

FIG. 10 illustrates a perspective view of hydraulic passageways within a lower portion of the cutter body.

FIG. 11 illustrates a perspective view of hydraulic passageways within an upper portion of the cutter body.

### DETAILED DESCRIPTION

Set forth below with reference to the accompanying drawings is a detailed description of embodiments of a cutting tool with hydraulically clamped cutting inserts.

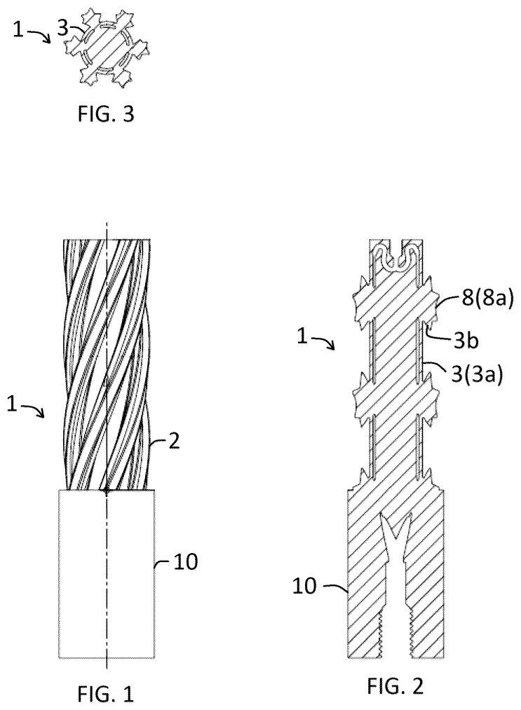

FIGS. 1-3 illustrate a cutter body 1 of a cutting tool according to an exemplary embodiment. The cutter body 1 includes a shank 1a and a head 2. Helically arranged along an outer surface of the head 2 are a plurality of dovetail-shaped insert-holding slots 3. In particular, because the slots 3 extend helically, the dovetail shape is visible in both a cross section taken in a plane that is parallel to the central axis of the cutter body 1, i.e., in FIG. 2, and in a cross section taken in a plane that is perpendicular to the central axis of the cutter body 1, i.e., in FIG. 3.

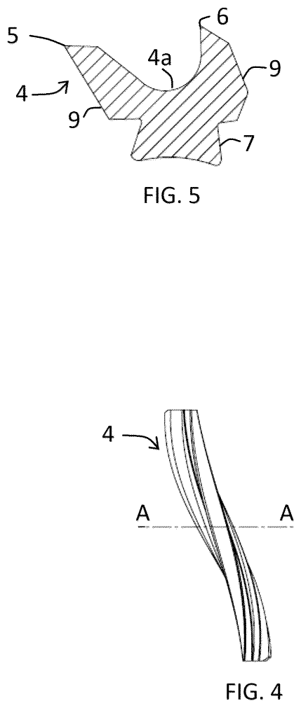

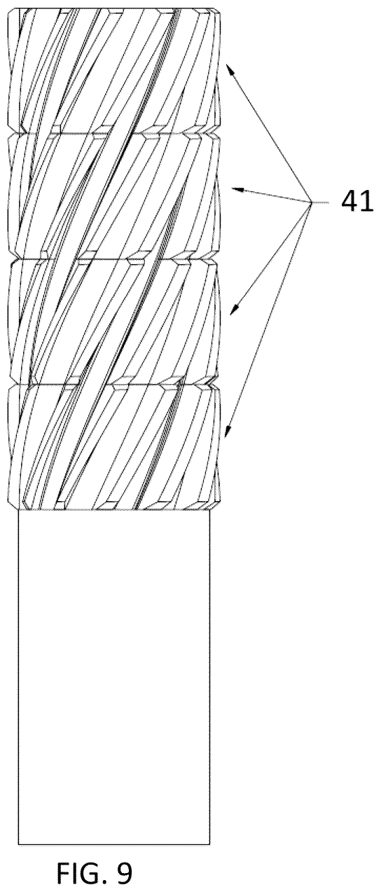

FIGS. 4 and 5 illustrate a cutting insert 4 configured to be held in one of the insert-holding slots 3. In the embodiment, the cutting insert 4 is helical-shaped and includes first and second cutting edges 5 and 6 and a dovetail-shaped portion 7 whose geometry matches that of the insert-holding slot 3, as seen in FIGS. 6-8, which illustrate the cutter body 1 with the cutting inserts 4 installed. As seen in FIG. 5, sidewalls 9 of the cutting insert 4 that are above the dovetail-shaped portion 7 terminate in the cutting edges 5 and 6. Although two cutting edges are shown per cutting insert, the number of cutting edges can be one, or can be three or more. In the exemplary embodiment of FIGS. 1-8, each cutting insert 4 is approximately the length of the insert-holding slot 3. As seen as the FIG. 9 variation, there can be a plurality of shorter cutting inserts 41 per insert holding slot 3.

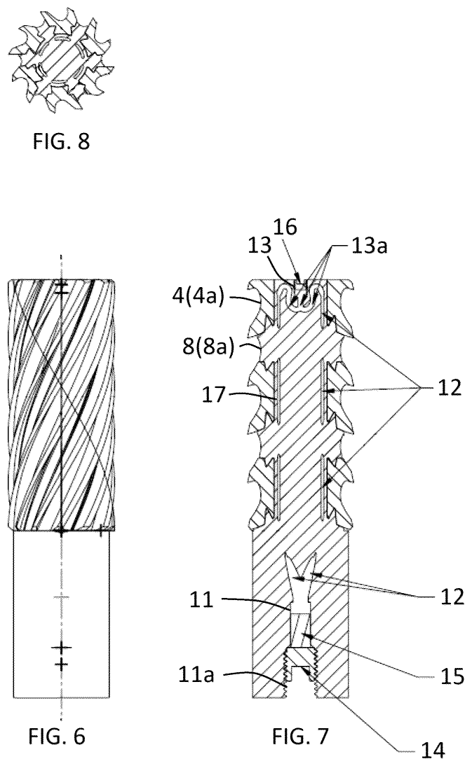

In the areas of the head 2 between the slots 3, there is a projection 8 which is configured to mate with the sidewalls 9 of the cutting insert 4. As seen in the FIG. 2 cross-section, the radially-outward facing surface 8a of the projection 8 is concave. Similarly, as seen in FIG. 5, the radially outward-facing surface 4a of the cutting insert 4, between the cutting edges 5 and 6, is concave. Both concave radially outward-facing surfaces 4a and 8a are also visible in FIG. 7. When the tool is in use, the concave radially outward-facing surfaces 4a and 8a define passageways for milled material to be able to exit the vicinity of the tool.

The cutter body 1 further includes hydraulic passageways which, when hydraulic fluid disposed therein is pressurized, cause the radially outward-facing surface 3a of the insert-holding slot 3 to be pressed toward the radially-inward facing surfaces 3b of the insert-holding slot 3. The cutter body 1 is configured such that this hydraulic pressurization will apply a hydraulic clamping force to the cutting insert 3 such that it is held within the insert-holding slot 3 with sufficient force such that it is not dislodged when the cutting tool is in use. In particular, as illustrated in FIG. 7, the hydraulic passageways, specifically the helical passageways 12 described in detail below, extend directly under the radially outward-facing surfaces 3a to define a thin wall 17 therebetween that will expand generally radially outward when the hydraulic pressure is applied. When the hydraulic pressure is not applied, the cutting inserts 4 can slide within the insert-holding slots 3.

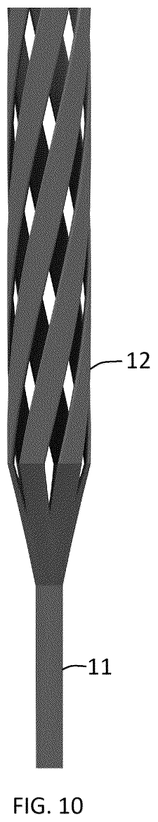

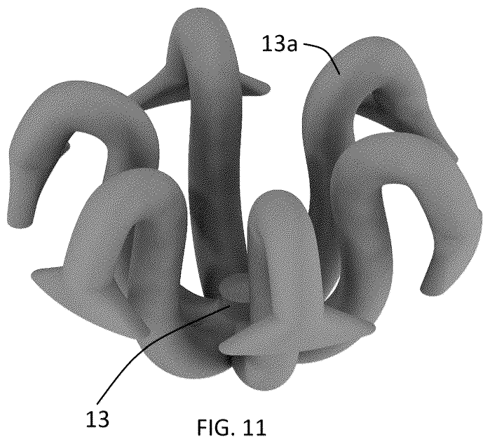

FIGS. 10 and 11 illustrate a visualization of the hydraulic passageways. As illustrated in FIG. 10, a central entrance passageway 11, into which the hydraulic fluid is introduced, splits into the helical passageways 12 that extend under the respective helical insert-holding slots 3. At the opposite end of the cutter body 1, the helical passageways 12 re-combine into a threaded central exit passageway 13 via bleed channels 13a, as illustrated in FIG. 11. As seen in FIG. 7, a piston screw 14 is threaded to a threaded portion 11a of the central entrance passageway 11, and a plunger 15 is disposed in the portion lacking threads. As the piston screw 14 is rotated to advance further into the central passageway 11, the plunger 15 is also advanced, pressurizing the hydraulic fluid. As also seen in FIG. 7, a plug 16 is threaded into the central exit passageway 13 to block egress of hydraulic fluid.

To install the cutting inserts 4, they are first slid into place along the insert-holding slots 3 from the top end of the cutting tool 1, while the hydraulic pressure is not applied. The hydraulic pressure is then applied by advancing the piston screw 14. The hydraulic pressure causes the radially-outward facing surfaces 3a to be pressed further outward, clamping the dovetail-shaped portions 7 of the cutting inserts 4 between the respective radially-outward facing surfaces 3a and radially-inward facing surfaces 3b of the respective insert-holding slots 3. To remove the cutting inserts 4, the process is reversed, i.e., the piston screw 14 is moved outward from the central entrance passageway 11 to relieve the hydraulic pressure, and then the cutting inserts 4 are slid out of the insert-holding slots 3 from the top of the cutting tool 1.

Exemplary materials forming the cutter body include steel, iron, aluminum, titanium, magnesium, polymer, carbon, and copper (including all alloys, tempers, grades, and composites of the aforementioned materials). Exemplary materials forming the cutting insert include steel (e.g. high-speed steel, other tool-grade steels), carbides, ceramics, and cermets. The cutting insert may be applied uncoated, or it may be coated.

Exemplary manufacturing methods for forming the cutter body 1 and cutting insert 4 include traditional manufacturing methods, as well as additive manufacturing methods such as 3D printing. For example, the cutter body 1 could be formed by multiple cast metal parts, which are then brazed or otherwise fixed together. In one such embodiment, a sleeve which defines the thin walls 17 and projections 8 of the head 2 is separately formed from a base which defines the shank 1a and the remainder of the head 2. When formed in this fashion, the base will thus have an outer surface with concavities defining the portions of the fluid passageways that are disposed under the thin walls 17 (i.e., the helical passageways 12). Alternatively, such as when the cutter body is 3D printed, it can be monolithically formed as a single piece.

Cutting tools according to the foregoing embodiments provide reliable, cost effective solutions for fixation of the cutting inserts into the cutter bodies. Furthermore, as there are no external connectors needed, the maximum number of cutting edges per unit length is higher.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

For purposes of the description above, it is to be understood that the invention may assume various alternative variations and step sequences except where expressly specified to the contrary. Moreover, all numbers expressing, for example, dimensions used in the specification and claims, are to be understood as being modified in all instances by the term “about”. Accordingly, unless indicated to the contrary, the numerical parameters set forth are approximations that may vary depending upon the desired properties to be obtained by the present invention. At the very least, and not as an attempt to limit the application of the doctrine of equivalents, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A cutting tool comprising:
a cutter body having an outer surface and a plurality of insert-holding slots formed in the outer surface; and
a plurality of cutting inserts held in the plurality of insert-holding slots by application of hydraulic clamping force on the plurality of cutting inserts.

2. The cutting tool according to claim 1, wherein the plurality of cutting inserts and the plurality of insert-holding slots extend helically.

3. The cutting tool according to claim 1, wherein each of the plurality of insert-holding slots holds more than one of the plurality of cutting inserts.

4. The cutting tool according to claim 1, wherein the cutter body includes one or more hydraulic passageways configured to, when hydraulic fluid disposed therein is pressurized, cause walls of the plurality of insert-holding slots to apply the hydraulic clamping force to the plurality of cutting inserts.

5. The cutting tool according to claim 1, wherein each of the plurality of cutting inserts includes a dovetail-shaped portion to which the hydraulic clamping force is applied.

6. A method of manufacturing a cutting tool, comprising:
disposing a plurality of cutting inserts in a plurality of insert-holding slots formed in an outer surface of a cutter body; and
holding the plurality of cutting inserts in the plurality of insert-holding slots by applying hydraulic clamping force to the plurality of cutting inserts.

7. The method according to claim 6, wherein the plurality of cutting inserts and the plurality of insert-holding slots extend helically.

8. The method according to claim 6, wherein each of the plurality of insert-holding slots holds more than one of the plurality of cutting inserts.

9. The method according to claim 6, wherein the cutter body includes one or more hydraulic passageways configured to, when hydraulic fluid disposed therein is pressurized, cause walls of the plurality of insert-holding slots to apply the hydraulic clamping force to the plurality of cutting inserts.

10. The method according to claim 6, wherein each of the plurality of cutting inserts includes a dovetail-shaped portion to which the hydraulic clamping force is applied.
